(19) United States
(12) Patent Application Publication
(10) Pub. No.: US 2004/0168657 A1
(43) Pub. Date: Sep. 2, 2004

(54) Internal combustion engine with variable compression ratio

(76) Inventor: De Lambertus H. Gooijer, Naarden (NL)

Correspondence Address: Steven M Koehler, Westman Champlin & Kelly, International Centre Suite 1600, 900 Second Avenue South, Minneapolis, MN, 55402-3319, US

(21) Appl. No.: 10/473,609

(22) PCT Filed: Mar. 27, 2002
(86) PCT No.: PCT/EP02/03525

(30) Foreign Application Priority Data
Mar. 30, 2001 (EP) 01201203.5

(51) Int. Cl. F02B 75/04

(52) U.S. Cl. 123/78 F

(57) ABSTRACT

The invention relates to an internal combustion engine, which comprises a engine block (1) including a crankshaft (5) having at least a crank (6). The crankshaft (5) is journalled on bearings (9) which are mounted in adjustable eccentrics (10), rotation of the eccentrics causing relative repositioning of the crankshaft centerline (8) and the engine block (1) in order to adjust the compression ratio of the piston in its cylinder. The engine further comprises a gearbox (2) having an input shaft (15) connected to the crankshaft (5). The gearbox (2) and the engine block (1) are mounted to each other in such manner that the engine block and gearbox are relatively repositioned simultaneously with a crankshaft repositioning. The engine block (1) is substantially stationary and the gearbox (2) is operatively coupled to the eccentrics (10) such that the gearbox input shaft (15) is kept aligned with the crankshaft (5) when this crankshaft is repositioned. The gearbox has means (21) to prevent rotation of the gearbox relative to the engine block.

The invention relates to an internal combustion engine with variable compression ratio according to the preamble of claim 1.

An engine of this type is for example known from U.S. Pat. No. 5,605,120. In this prior art engine, the engine block is supported by a frame in an adjustable manner, such that upon relative repositioning of the crankshaft centerline and the engine block, it is the engine block that is repositioned with respect to the frame. This means that the engine block should be mounted in the vehicle in a movable manner. The problem is then that all kinds of co-operating parts, such as for example the exhaust, waterhoses, electrical wiring etc., must be able to adopt or absorb this movements. This makes the engine complex.

EP-A-0 345 366 discloses an engine comprising a flange connected to the eccentric main bearing assembly which rotates around the friction group to activate several micro-switches for compression ratio information. The gearbox is mounted rigidly to the external friction housing. The misalignment of crankshaft and coupling is compensated using a special gearing on the gearbox side.

GB-A-173,252 discloses an internal combustion engine comprising an adjustable crankshaft to obtain a variable compression. The output shaft of the gearbox remains stationary and there is provided a flexible drive between the crankshaft and the gearbox shaft to compensate for the misalignment.

The object of the present invention is to provide an improved internal combustion engine with variable compression ratio.

For this purpose, the internal combustion engine according to the invention has the features of the characterising portion of claim 1.

According to the invention, the engine block can be kept stationary and it is the gearbox that is moving in order to keep the crankshaft and the gearbox input shaft in alignment. The movement of gearbox is easier to adopt, since the output shaft of the gearbox or the drive shafts of the differential can more easily be adapted to movements of the gearbox than, for example the exhaust, to movements of the engine block.

In one embodiment of the engine, the eccentrics have a gearbox flange outside the engine block, said gearbox flange having the same eccentricity as the eccentrics and supporting the gearbox through a bearing.

In this way, the movement of the eccentrics and the gearbox is synchronised mechanically so that the crankshaft and the input shaft of the gearbox remain in line.

Further advantageous embodiments are subject of dependent claims.

The invention will hereafter be explained in more detail with reference to the drawings, showing embodiments of the engine according to the invention by way of example.

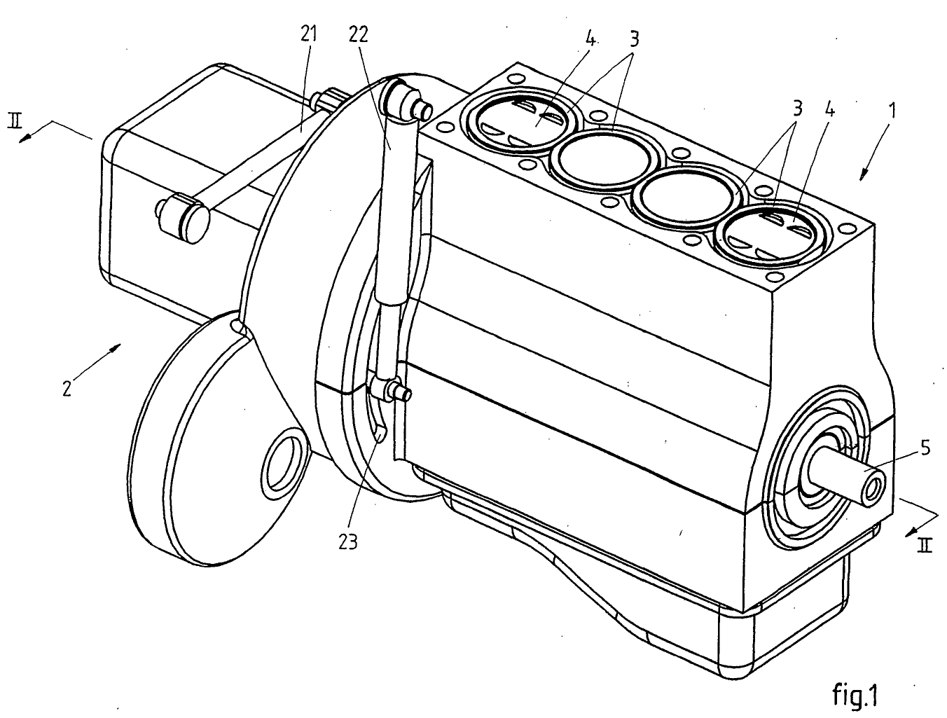

FIG. 1 is a perspective view of an engine block and gearbox of a first embodiment of the internal combustion engine according to the invention.

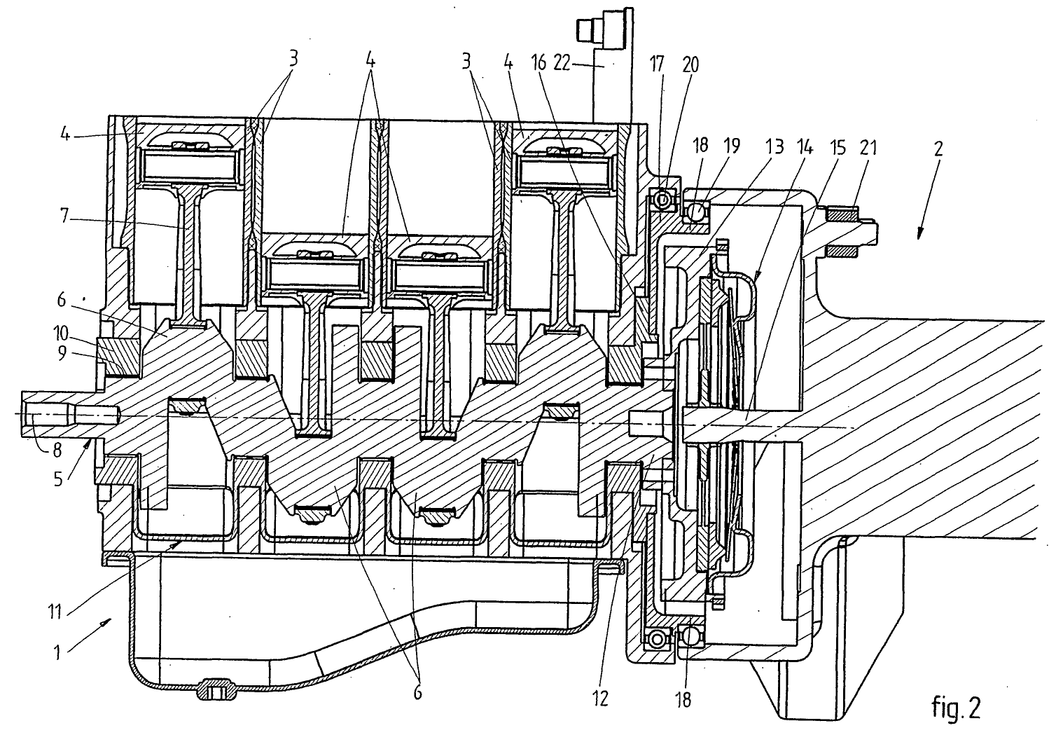

FIG. 2 is a sectional view along the line II-II in FIG. 1, on a larger scale.

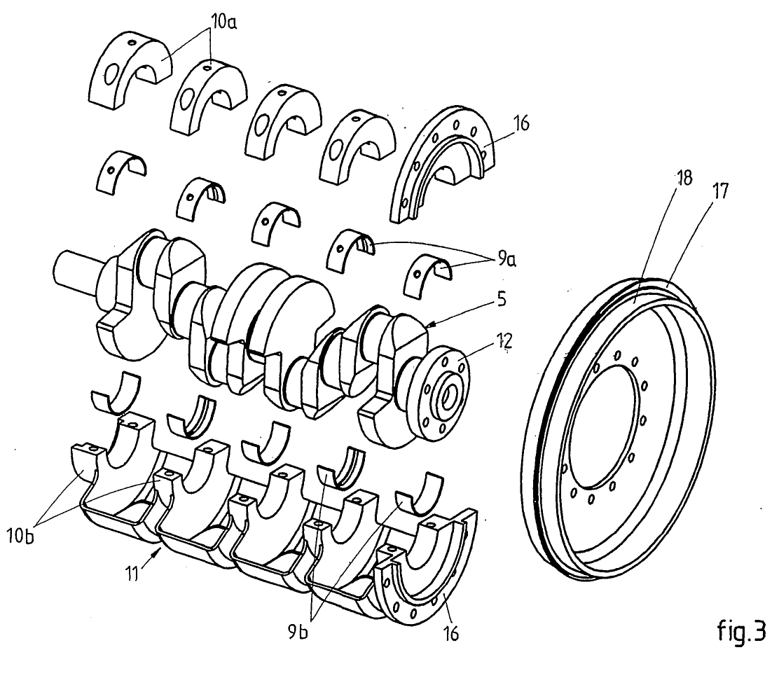

FIG. 3 is a perspective exploded view of the crankshaft and eccentric bearings from the engine according to FIG. 2.

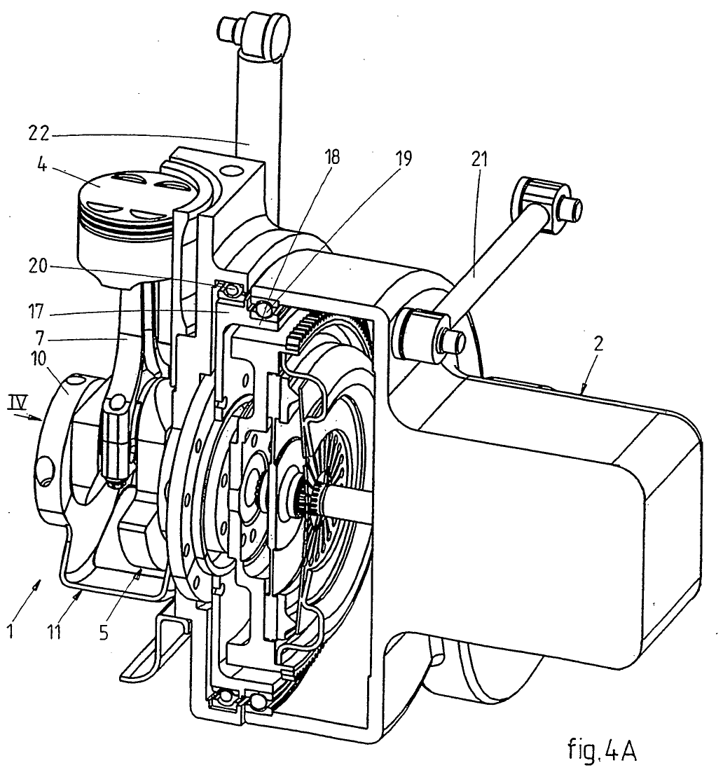

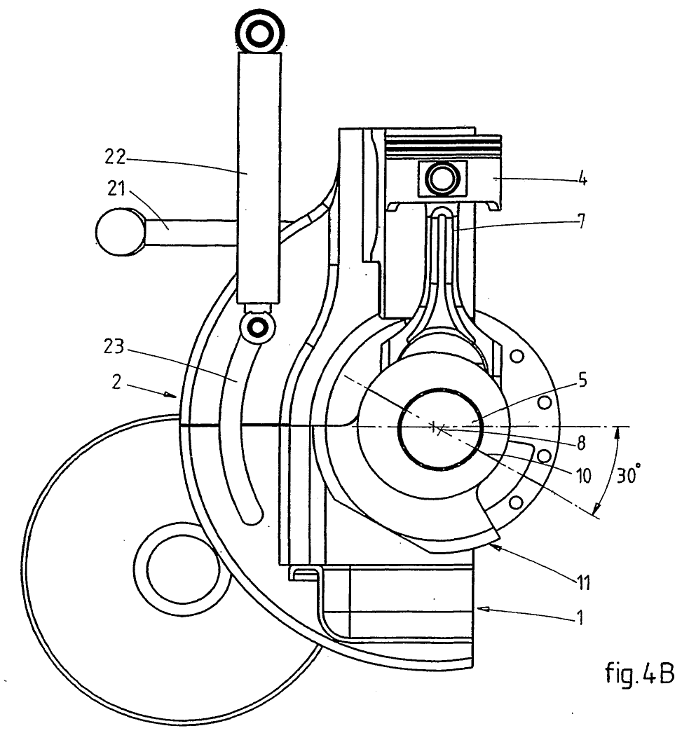

FIG. 4a is a perspective side view of a part of the engine of FIG. 2, partly cut away, and shown in a position of the eccentrics to effect a minimum compression ratio.

FIG. 4b is a front view according to arrow IV in FIG. 4a.

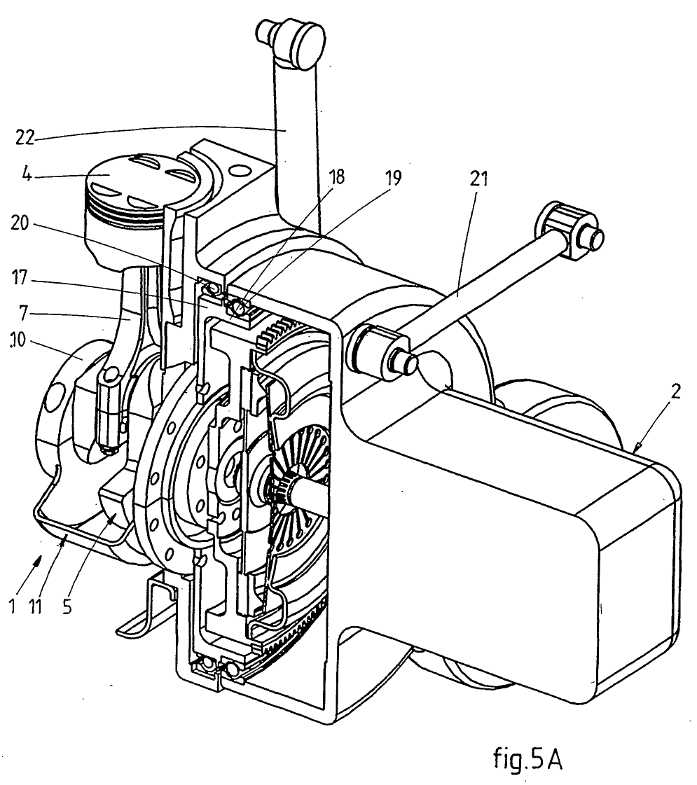

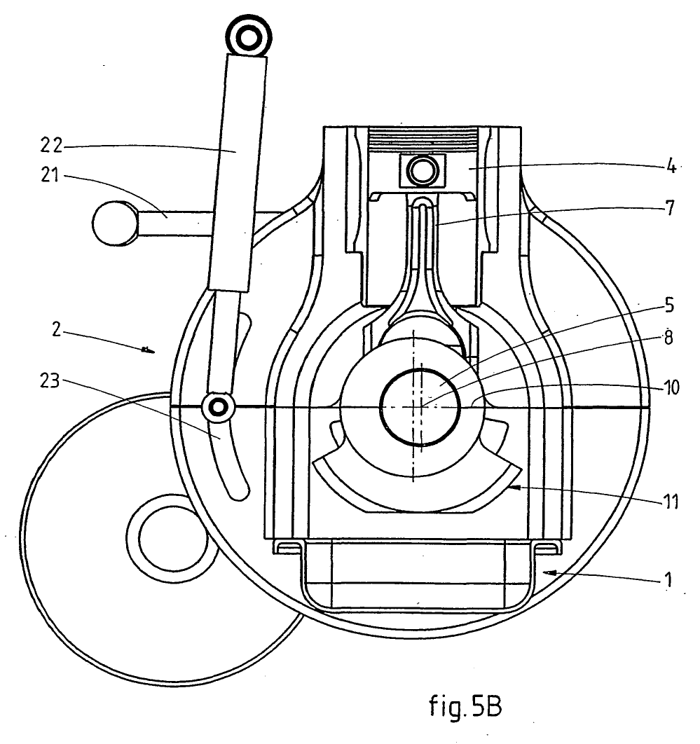

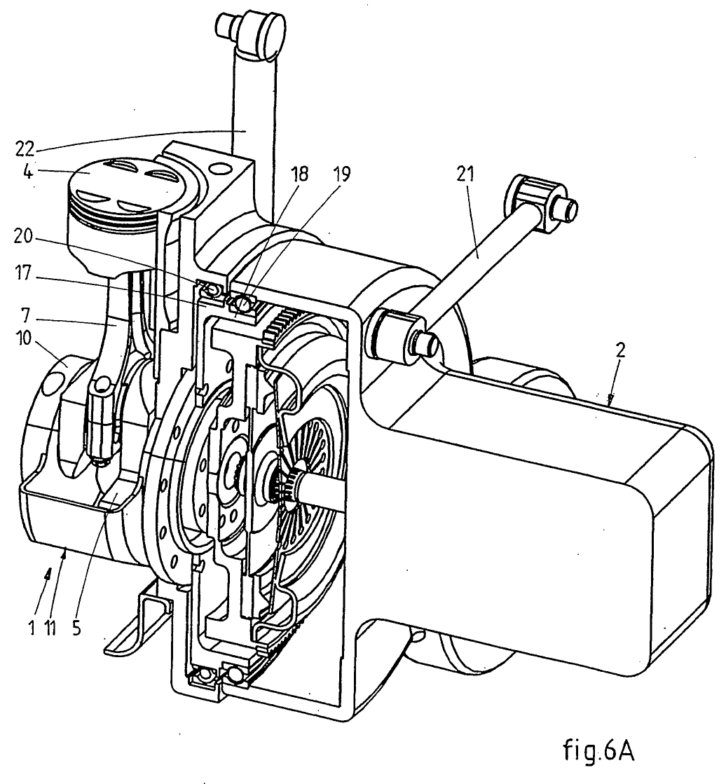

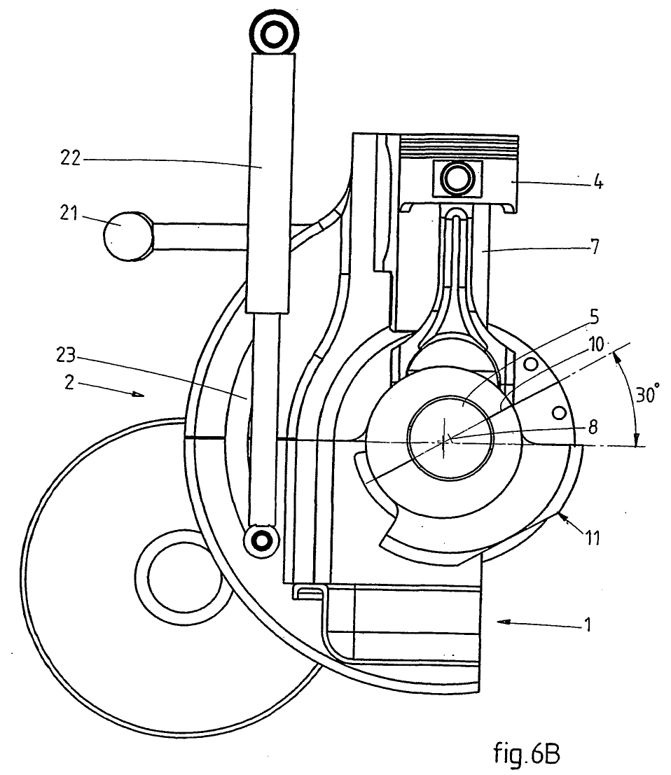

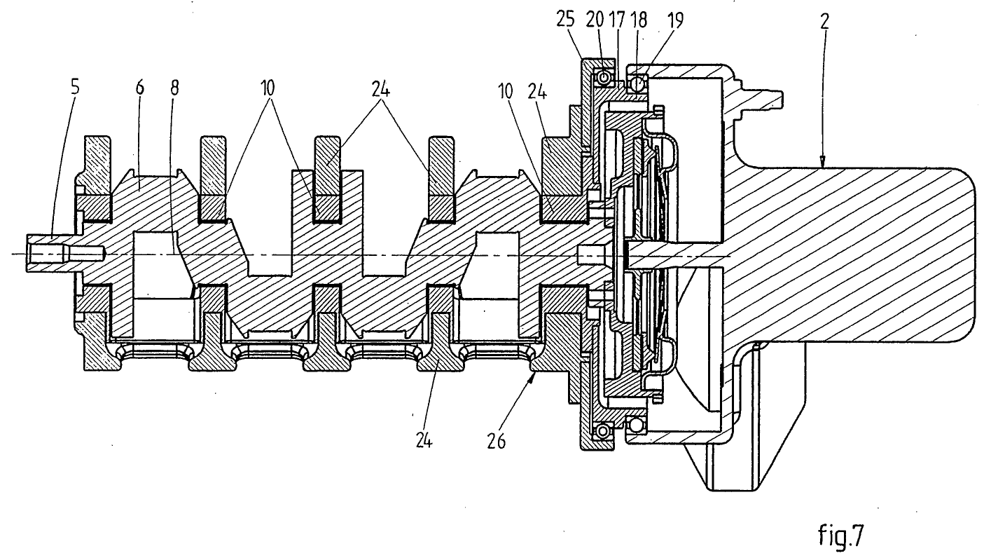

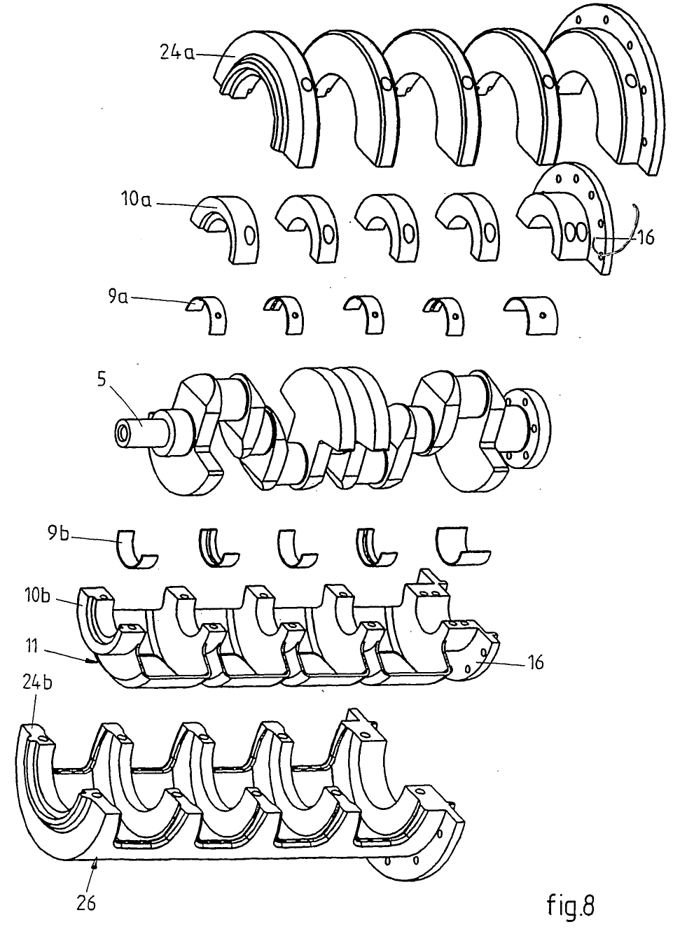

FIGS. 5a, 5b and 6a, 6b are views corresponding to those of FIG. 4a, 4b, but shown in a position effecting medium compression ratio and a position effecting maximum compression ratio.

FIG. 7 is a view corresponding to that of FIG. 2 and showing a second embodiment of the engine according to the invention.

FIG. 8 is a perspective exploded view of the crankshaft and eccentrics from the engine of FIG. 7.

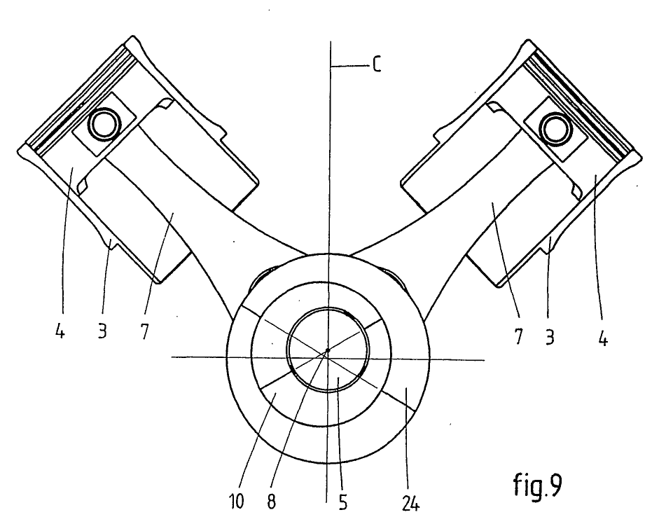

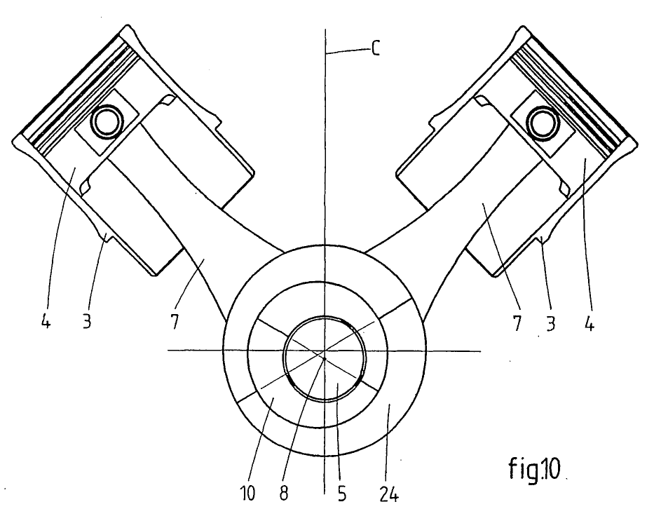

FIGS. 9 and 10 illustrate the effect of the double eccentrics in the embodiment of FIGS. 7 and 8.

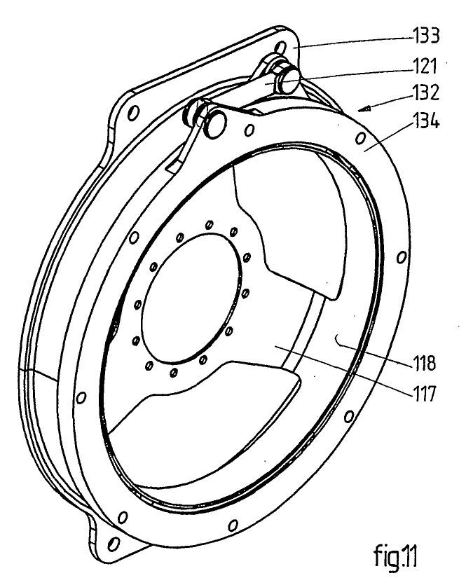

FIG. 11 is a perspective view of a gearbox flange unit of a further embodiment of the engine according to the invention.

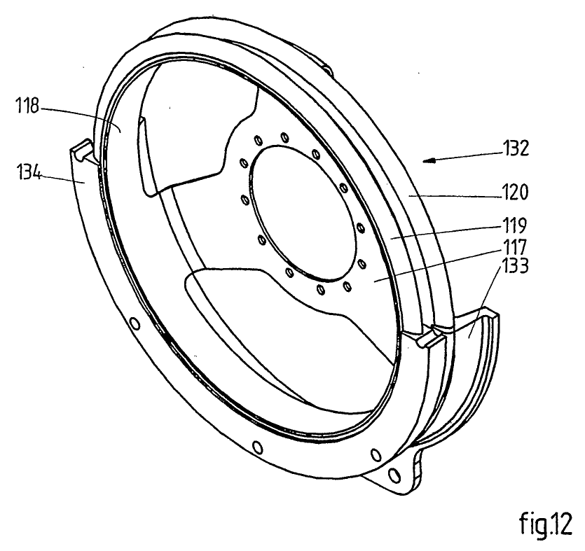

FIG. 12 is a partly cut away perspective view of the gearbox flange unit of FIG. 11, viewed from another angle.

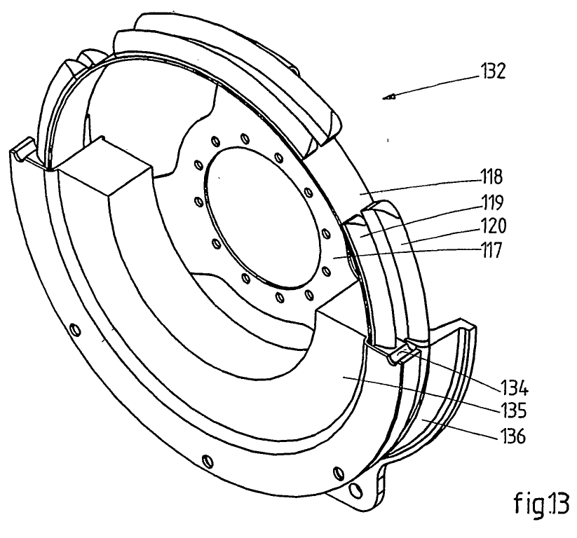

FIG. 13 is a view corresponding to that of FIG. 12, but including a stator of a starter motor/generator and modified bearings.

The drawings show embodiments of an internal combustion engine comprising an engine block 1 and a gearbox 2 mounted thereto. If the engine is used in a vehicle having front wheel drive, the gearbox also includes the differential with the drive shafts for the front wheel axles. The gearbox housing also includes a flywheel housing. The engine can be of the Diesel or Otto type. FIGS. 1 and 2 show that the engine in the first embodiment is a four cylinder in-line engine having four cylinders 3 and four pistons 4 reciprocating therein. A crankshaft 5 is rotatably mounted within the engine block 1 to convert the reciprocating movement of the pistons 4 into a rotating movement. The crankshaft 5 has four cranks 6 each rotatably supporting a piston rod 7 rotatably connected at the opposite, upper end to the respective piston 4.

The stroke of each piston 4 within its cylinder 3 is determined by the radius of the centerline of the cranks 6 with respect to the centerline or axis of rotation 8 of the crankshaft 5. The stroke is two times this radius and since the radius is fixed, the stroke of the pistons 4 is fixed as well. However, the end positions of the stroke depend on the position of the centerline 8 of the crankshaft 5 and if the position of this centerline is changed, the upper and lower dead center will change as well. This repositioning of the crankshaft centerline 8 can be used to obtain a variable compression ratio. The compression ratio is the ratio between the volume of the cylinder 3 above the piston 4 in its lower dead center and the volume of the cylinder above the piston in its upper dead center. Moving the centerline 8 of the crank shaft 5 away from the cylinders 3 will lead to a lower compression ratio, whereas the compression ratio will be increased when the centerline 8 of the crank shaft 5 is moved towards the cylinders 3.

The repositioning of the crankshaft centerline 8 is effected by having the crank shaft 5 journalled in bearings 9 which are accommodated in eccentrics 10. FIG. 3 shows the structure of the bearings 9 and eccentrics 10. The crankshaft 5 has five main bearings 9 consisting of slide bearings formed by upper bearing cups 9a and lower bearing cups 9b. The eccentrics 10 are constructed as bushes formed from two halves, the lower bush halves lob being integrated in a eccentric assembly 11, whereas the upper bush halves 10a are separate halve bushes which are fixed to the lower bush halves 10b by fasteners such as bolts or screws. The lower bush halves 10b are interconnected by shells such that the crankwebs of the crankshaft rotate inside them. As the shells are only provided at the lower side, the upper bearing cups 9a are of normal width, whereas the lower bearing cups 9b are of smaller width in order to create room for the shells. These shells are cut away at 30° on their upper side to enable a rotation of the eccentric assembly 11 of +/−30°.

The eccentrics or bushes 10 have an eccentricity of a few millimeters, for example 5 mm. By rotation of these eccentrics 10 in their bearings in the engine block 1, the horizontal and vertical position of the bearings 9 within the eccentrics 10, and therefore of the crankshaft centerline 8 is changed. This will be further explained later-on with reference to FIGS. 4-6. In the embodiment as shown, the maximum rotation of the eccentrics is 60°, i.e. 30° in each direction from the central position.

The crankshaft 5 has on one end a flywheel or crankshaft flange 12 to fix the crankshaft to the gears of the gearbox, in this case through a flywheel 13 and a coupling 14, which connects to an input shaft 15 of the gearbox which is not further shown.

As the position of the crankshaft centerline 8 relative to the engine block changes upon rotation of the eccentrics 10, it is necessary that the gear box 2 changes its position as well such that the input shaft 15 of the gear box is kept aligned with the crankshaft 5. For this purpose, the gearbox 2 is moveably connected to the engine block 1 such that the gearbox is repositioned simultaneously with a repositioning of the crank shaft 5.

In order to effect this, the eccentric assembly 11 has a flange 16 to which a gearbox flange 17 is mounted and this flange 17 has a rim 18 which has the same eccentricity as the eccentrics 10 and is positioned in a manner to keep the input gearbox input shaft 15 in line with the crankshaft 5. The rim 18 supports the gearbox 2 through a large roller bearing 19. The gearbox flange 17 has an additional support in the engine block 1 through a roller bearing 20.

In order to prevent the gearbox 2 from rotating together with the crankshaft 5 or together with the gearbox flange 17, there is provided a reaction rod 21. This is positioned substantially horizontally (or substantially perpendicularly to the plane of symmetry through the cylinders 3) and connects to the gearbox 2 at the position outside the centerline. The other end of the reaction rod 21 is mounted to a fixed part of the vehicle or to a part fixed to the engine block 1.

The purpose of the variation of the compression ratio is to adapt the compression ratio to the engine conditions, as load, rotational speed and the like, in order to improve the efficiency of the engine. This means that the compression ratio should be varied continuously and should be controlled by an electronic control system which measures said conditions as input variables. In this embodiment, the eccentrics 10 are adjusted by an external adjustment member in the form of a hydraulic cylinder 22 controlled by the electronic control system and connected to the gearbox flange 17 through a slot 23 in the gearbox or flywheel housing. The slot has a length of arc of 60°. The hydraulic cylinder 22 is connected at its other end to the cylinder head of the engine block, for example.

In FIGS. 4, 5 and 6 the operation of the invention is illustrated.

In FIG. 4a and 4b, the eccentrics 10 are positioned such that the compression ratio is at a minimum. It is clearly shown in FIG. 4a that the adjustment member 22 is in its top position wherein the eccentrics are rotated 30° from the central position such that the crankshaft 5 is moved downwardly from this central position. Thus, the crankshaft is in its lowest position so that the piston 4 has its lowest top dead center and therefore a minimum compression ratio. As is shown FIG. 4b, the rim 18 of the gearbox flange 17 is also in a low position in which the input shaft 15 is aligned with the crankshaft 5. In FIG. 5a and 5b the adjustment member 22 is in its central position, which is also true for the crankshaft 5, the piston 4 and the rim 18 of the gearbox flange 17.

In FIG. 6a and 6b, the adjustment member 22 is in a downward position, the eccentrics 10 being rotated 30° in a direction in which the crankshaft 5 is displaced upwardly. Thus, the piston can reach the highest top dead center and the compression ratio is then at a maximum. The gearbox 2 has moved correspondingly.

It is noted that the crankshaft 5 and the gearbox 2 do not move in a straight line but follow a curved path. However, the central position of the eccentrics is chosen such that the horizontal displacement is at a minimum in relation to the vertical displacement. The horizontal displacement does not have a detrimental effect on the dynamics of the crankshaft-piston mechanism.

FIGS. 7 and 8 show a second embodiment of the internal combustion engine having a variable compression ratio. In this embodiment, the invention is used in an engine in which the cylinders are positioned in a V-shape. In this case it is a V8 engine with two piston rods positioned on each crank 6 of the crankshaft 5. In this embodiment it is important that the centerline 8 of the crankshaft 5 moves in the center plane C (see FIGS. 9 and 10) of the cylinder banks in order to obtain the same compression ratio in each cylinder (in all eccentric positions of the crankshaft 5). In order to have the crankshaft displaced within the center plane, the eccentrics 10 are supported by second eccentrics 24 which have the same eccentricity (in mirror image) as the eccentrics 10, but are adjusted or rotated in opposite direction. In this way, the movements of the eccentrics 10, 24 in a direction perpendicular to the center plane are neutralized, whereas the displacements within the center plane are added. The opposite rotation of both eccentrics 10 and 24 can be obtained by two mechanically or electronically synchronized adjustment members, or by some kind of connection member between both eccentrics 10 and 24 reversing the rotation of one eccentric 10 into an opposite rotation of the other one.

FIG. 8 shows that the eccentrics 24 are formed of lower bush halves 24b integrated in a eccentric assembly 26 and separate upper bush halves 24a fixed to the lower bush halves 24b. The whole assembly could be introduced into the engine block through a side opening of the engine block.

The centerline of the rim 18 is again aligned with the centerline 8 of the crankshaft 5. The gearbox flange 17 though is now supported by the second eccentric assembly 26 via the support flange 25. Because the second eccentric assembly is a very rigid structure, it is not necessary to support the second eccentric assembly 26 by the engine block 1.

FIGS. 9 and 10 illustrate two extreme positions of the eccentrics 10 and 24, and consequently of the top dead center of the pistons 4.

FIGS. 11-13 show a further embodiment of the invention, in this case in the form of a gearbox flange unit 132. This unit can be mounted, e.g. flanged, between the engine block 1 and the gearbox housing 2 and as such replaces the flywheel housing. It includes a gearbox flange 117 attachable to the eccentric assembly 11 of the crankshaft 5, an engine block part 133 attachable to the engine block 1 and a gearbox part 134 which is adapted to be attached to the gearbox 2. In this embodiment, the gearbox flange 117 is concentric with the crankshaft centerline 8, so that this gearbox flange 117 has an eccentricity which is equal to that of the crankshaft 5. This is done to enable a flywheel to rotate inside a rim 118 of the gearbox flange 117.

As the engine block part 133 is fixed to the engine block 1, the rim 118 is aligned with the crankshaft centerline and includes an eccentric slide bearing 120 aligned with the eccentric assembly 11 to allow an eccentric rotation of the gearbox flange 117 within the engine block part 133. A slide bearing 119 of the gearbox flange 117 is concentric with the gearbox flange 117 and thus with the crankshaft and rotatably supports the gearbox part 134. Due to this arrangement, the gearbox part 134 and therefore the gearbox 2 will follow the movements of the crankshaft 5 and will keep the input shaft 15 aligned with the crankshaft. The reaction rod 121 interconnects the gearbox part 134 and the engine block part 133 to prevent rotation of the gearbox 2.

FIG. 13 shows the gearbox flange unit 132 with a stator 135 which is mounted to the gear box part 134. The stator 135 is part of a starter motor and/or of a generator in a hybrid engine. It is preferred to mount the stator 135 to the gearbox part 134 since it does not rotate and therefore does not interfere with the electrical wires of the stator. The forces on the stator 135 are absorbed by the reaction rod 121 without any problems. The gearbox flange unit 132 is compact and can simply be mounted as a unit between the engine block 1 and the gearbox 2.

In this embodiment according to FIG. 13 it is shown that the slide bearing cones 119 and 120 are interrupted and each consist of four separate segments. The advantage thereof is that these segments facilitate mounting the bearings between the rim 118 of the gearbox flange 117 and the engine block part 133 and gearbox part 134 respectively. The bearing segments can now be mounted into the corresponding recesses in said parts 133 and 134 whereafter the rim 118 may be slid axially into and fixed to the bearings 119 and 120.

According to the invention there is obtained an easy adjustment of the compression ratio, whereas the proper alignment of the crankshaft and the input shaft of the gearbox is maintained in a relatively simple manner. The movements of the gearbox with respect to the engine block can be adopted easily by the output shaft of the gearbox (or drive shafts of the differential), since it will include a cardan joint anyhow. The engine block can remain stationary. The reaction rod to prevent rotation of the gearbox can be used to measure the torque of the engine.

The invention is not restricted to the embodiments described above and shown in the drawing, which may be varied in different ways within the scope of the invention. For example, the adjustment member could also be arranged internally, for instance in the oil sump. The adjustment member may be a hydraulic cylinder or an electric motor, such as a stepping motor connected to the eccentric assembly through a worm wheel drive or the like.

1. Internal combustion engine, comprising a engine block (1) with at least one cylinder (3), a crankshaft (5) having at least a crank (6) and being rotatably supported within the engine block, at least one piston (4) reciprocable within the cylinder and having a piston rod (6) mounted to the piston on one end and mounted to the crank of the crankshaft on the other end, said crankshaft (5) being journalled on bearings (9) which are mounted in adjustable eccentrics (10), rotation of the eccentrics causing relative repositioning of the crankshaft centerline (8) and the engine block (1) in order to adjust the compression ratio of the piston in its cylinder, the engine further comprising a gearbox (2) having an input shaft (15) connected to the crankshaft (5), the gearbox (2) and the engine block (1) being mounted to each other in such manner that the engine block and gearbox are relatively repositioned simultaneously with a crankshaft repositioning, characterized in that the engine block (1) is substantially stationary and the gearbox (2) is operatively coupled to the eccentrics (10) such that the gearbox input shaft (15) is kept aligned with the crankshaft (5) when this crankshaft is repositioned, the gearbox having means (21;121) to prevent rotation of the gearbox relative to the engine block.

2. Engine according to claim 1, wherein the eccentrics (10) have a gearbox flange (17;117) outside the engine block (1), said gearbox flange having the same eccentricity as the eccentrics and supporting the gearbox through a bearing (19;119).

3. Engine according to claim 2, wherein the gearbox flange (17;117) is supported externally by the engine block (1) through a (roller) bearing (20;120).

4. Engine according to one of the preceding claims, wherein the eccentrics (10) comprise bushes journalled in a wall of the engine block (1) and including a crankshaft bearing (9) which is positioned eccentrically with respect to the bush centerline.

5. Engine according to claim 4, wherein the eccentrics (10) comprise two bushes, one on each side of the crank (6), said bushes being connected in a eccentric assembly (11) dimensioned and positioned so as to leave room for the piston rod (7).

6. Engine according to claim 4 or 5, wherein the crankshaft (5) is an integral part, whereas the eccentrics comprise a half shell containing integrated first bush halves (10b) and further comprise separate second bush halves (10a) attached to the first bush halves to form the bushes.

7. Engine according to one of the preceding claims, wherein the engine block (1) comprises at least two cylinders (3) positioned in-line.

8. Engine according to one of the preceding claims, wherein the eccentrics (10) are adjustable by means of an electronically controlled adjustment member (22).

9. Engine according to claim 8, wherein the adjustment member (22) is a hydraulic cylinder engaging a part which is connected to the eccentrics (10).

10. Engine according to claim 8 or 9, wherein the adjustment member (22) is mounted to the outside of the engine block (1) and engages the part connected to the eccentrics (10) through a hole in the wall of the engine block or gearbox (2).

11. Engine according to claim 10, wherein the adjustment member (22) engages the gearbox flange (17) connected to the eccentrics (10).

12. Engine according to claim 8, wherein the adjustment member is mounted internally of the engine block (1) and is preferably an electric motor, such as a stepping motor.

13. Engine according to one of the preceding claims, wherein the means (21) to prevent rotation of the gearbox (2) includes a reaction rod engaging the gearbox outside the center and preferably extending in a direction substantially perpendicularly to the cylinder (3) of the engine block (1).

14. Engine according to any one of claims 1-10, wherein the gearbox flange (117) is part of a gearbox flange unit (132) which is positioned between the engine block (1) and the gear box housing (2).

15. Engine according to claim 14, wherein the unit comprises a gearbox flange (117) fixed to the eccentric assembly (11), an engine block part (133) attached to the engine block (1) and a gearbox part (134) attached to the gearbox housing (2), said engine block part and gearbox part being rotatably connected to the gearbox flange (117) through bearings, said means (121) to prevent rotation of the gearbox (2) relative to the engine block (1) is mounted between the engine block part and the gearbox part.

16. Engine according to claim 15, wherein the gearbox flange (117) is concentric with the crankshaft, whereas the engine block part (133) is rotatably mounted on the gearbox flange through a bearing (120) having the same eccentricity as the eccentric assembly (11).

17. Engine according to one of the preceding claims, wherein the engine block (1) comprises at least two cylinders (3) positioned in V-shape having a center plane, the eccentrics (10) being rotatably supported by second eccentrics (24) having the same eccentricity but being adjusted in opposite direction, such that the eccentricities are a mirror image with respect to the center plane.

18. Internal combustion engine, comprising a engine block (1) with at least two cylinders (3), a crankshaft (5) having at least one crank (6) and being rotatably supported within the engine block, at least two pistons (4) reciprocable within their respective cylinder and having a piston rod (6) mounted to the piston on one end and mounted to the at least one crank of the crankshaft on the other end, said crankshaft (5) being journalled on bearings (9) which are mounted in adjustable eccentrics (10), rotation of the eccentrics causing relative repositioning of the crankshaft centerline (8) and the engine block (1) in order to adjust the compression ratio of the pistons in their cylinder, the engine further comprising a gearbox (2) having an input shaft (15) connected to the crankshaft (5), the gearbox (2) and the engine block (1) being gearbox are relatively repositioned simultaneously with a crankshaft repositioning, characterized in that the cylinders (3) of the engine are positioned in a V-shape having a center plane, wherein adjustable eccentrics (10) are supported by second eccentrics (24) having the same eccentricity as the first eccentrics (10) and being adjusted simultaneously with the first eccentrics, but in opposite direction, such that the eccentricities form a mirror image with respect to the center plane of the V-shape.

19. Gearbox flange unit for use in an internal combustion engine, comprising a gearbox flange (117) adapted to be fixed to an eccentric assembly (11) of a crankshaft, an engine block part (133) attachable to an engine block (1) and a gearbox part (134) attachable to a gearbox housing (2), said engine block part and gearbox part being rotatably connected to the gearbox flange (117) through bearings, and further comprising a member (121) to prevent rotation of the gearbox (2) relative to the engine block (1), said member being mounted between the engine block part and the gearbox part.

20. Gearbox flange unit according to claim 19, comprising a stator (135) which is part of a starter motor and/or of a generator and which is mounted to the gear box part (134).
